(19) United States
(12) Patent Application Publication
(10) Pub. No.: US 2018/0291949 A1
(43) Pub. Date: Oct. 11, 2018

(54) Detent Living Hinge

(71) Applicant: Dinh Le, Rosemead, CA (US)

(72) Inventor: Dinh Le, Rosemead, CA (US)

(21) Appl. No.: 15/484,434

(22) Filed: Apr. 11, 2017

(51) Int. Cl. F16C 11/12; E05D 1/00

(52) U.S. Cl. CPC F16C 11/12; E05Y 2900/132; E05Y 2900/606; E05D 1/00

(57) ABSTRACT

A detent living hinge can rotate freely, can flip open/close, and has detent mechanism for holding the connected components firmly in designated open/closed positions. The hinge's thin flexible strip adheres to the hinge component connectors and lets them rotate about the hinge axis. The hinge spring pulls the component connectors close together to their intended positions to keep the thin flexible strip from collapsing or getting overly stretched and twisted.

### FIELD OF THE INVENTION

The present invention relates to living and detent hinges.

### DESCRIPTION OF THE RELATED ART

Detent hinges are being used to hold doors open at specific angles and to flip clamshell mobile devices open/close. Detent hinges tend to have sophisticated cam/spring mechanism, multi precision parts, and bulky cam/spring/barrel/pin module. Detent hinges have smooth opening/closing motions that starts and ends in predictable positions. Devices with detent hinges seem intuitive and pleasing to open and close.

Living hinges are simpler, lower-cost, and one-piece with adequate but imprecise flexing rotational motion. Living hinges rotates less smoothly and predictably than detent hinges.

Having detent living hinges that can flip open/close smoothly is highly desirable in clamshell devices that demand compactness and smooth predictable motion.

### BRIEF DESCRIPTION OF THE INVENTION

The disclosed invention reveals a detent living hinge with 5 main features including a thin flexible strip, optional one or more hinge ridges, hinge spring slots, hinge spring, and hinge component connectors. The detent living hinge relies
on its thin flexible strip to rotate with little restraint;
on its hinge ridges and component connectors to keep the thin flexible strip evenly spaced and avoid collapsing onto itself;
on its thin flexible strip and hinge component connectors and ridges to rotate smoothly and predictably within a rotation zone;
on its hinge spring to hold the hinge component connectors and ridges close together and in doing so, protect the thin flexible strip from undesired stretching and twisting; and
on its hinge spring, spring slots, ridges, and component connectors to create bias force that favors the intended open and closed positions.

### BRIEF DESCRIPTION OF THE DRAWINGS

The figures are not necessary drawn to scale.

FIG. 1 is a side view of the detent living hinge without the hinge spring in its open position.

FIG. 2 is a top isometric view of the detent living hinge without the hinge spring in its open position.

FIG. 3 is a bottom isometric view of the detent living hinge without the hinge spring in its open position.

FIG. 4 is a side view of the complete detent living hinge in its open position.

FIG. 5 is a bottom isometric view of the complete detent living hinge in its open position.

FIG. 6 is a side view of the detent living hinge without the hinge spring in its closed position.

FIG. 7 is a side view of the complete detent living hinge in its closed position.

FIG. 8 is a bottom isometric view of the complete detent living hinge in its closed position.

### DETAILED DESCRIPTION

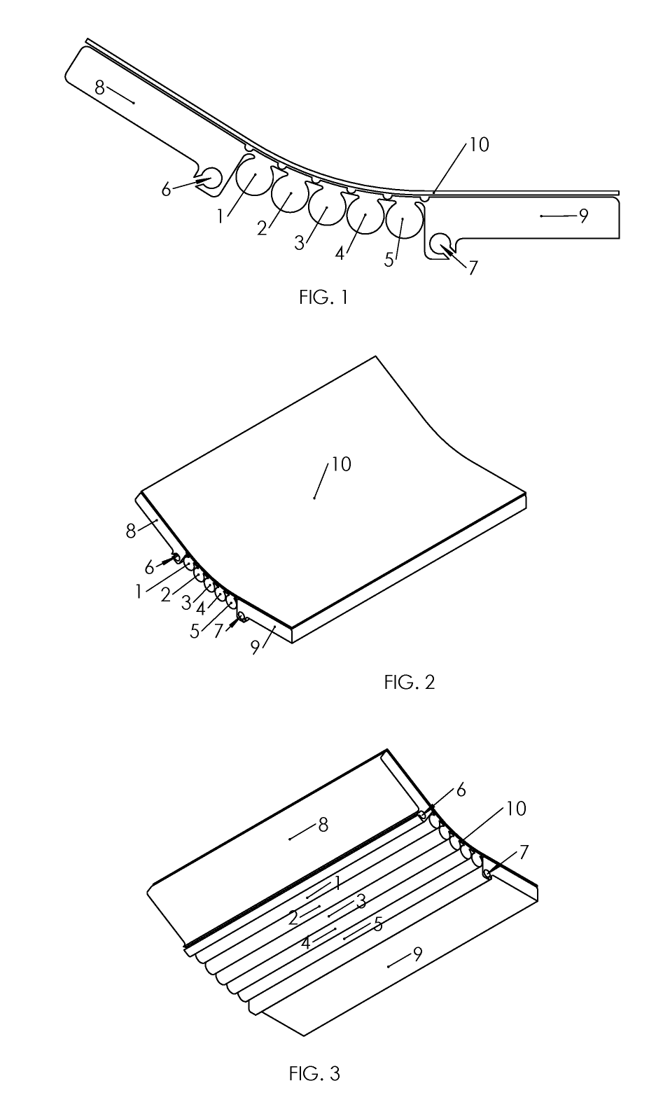

FIG. 1 illustrates a side view of the detent living hinge without the hinge spring (to be described later) in its open position. It shows four main features including the hinge ridges 1-5, hinge spring slots 6-7, hinge component connectors 8-9, and thin flexible strip 10. The thin flexible strip adheres to the hinge component connectors and ridges. The region where the hinge component connector adheres to the thin flexible strip is called the hinge component connector base. The region where the hinge ridge adheres to the thin flexible strip is called the hinge ridge base. From now on, we shall use the term “base” liberally when its intention is clear.

In its open position, hinge component connector 8 leans against hinge ridge 1 which leans against hinge ridge 2 which leans against hinge ridge 3 which leans against hinge ridge 4 which leans against hinge ridge 5 which leans against hinge component connector 9. The opening force that opens up the detent living hinge causes these features to lean against each other. The leaning of these features causes a counter-compressive force on the bottom side and counter-tensile force on the top side that prevents the hinge from opening up further.

Although the hinge component connectors and ridges are shown to be joined at their bases, these bases can be disjointed. The joints between the bases, if existed, are designed to keep the features spaced apart while allowing the adjacent bases to rotate freely at the joints. The thin flexible strip is thicker with stronger tensile strength than the joints but having the joints would provide more supports. The joints should be made as thin as possible to minimize the amount of additional rotation strain.

FIG. 2 shows a top isometric view of the detent living hinge, without the hinge spring, in its open position. The thin flexible strip 10 dominates the view but the side view of the hinge component connectors 8-9, spring slots 6-7, and ridges 1-5 can be seen on the bottom left corner.

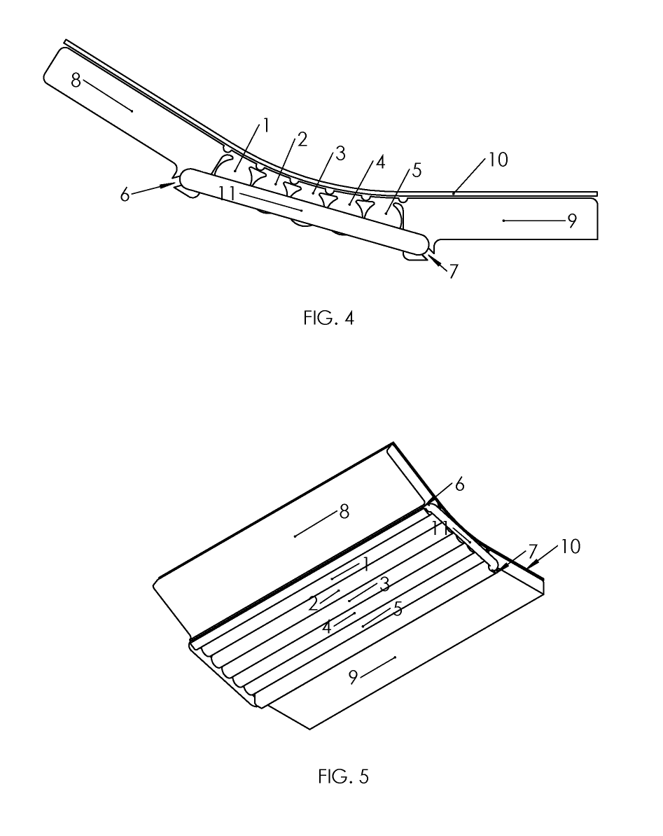

FIG. 3 shows a bottom isometric view of the detent living hinge, without the hinge spring, in its open position. The edge of the thin flexible strip 10 slightly appears on the upper right corner. The hinge component connectors 8-9, springs slots 6-7, and ridges 1-5 are clearly in view.

FIG. 4 shows a side view of the complete detent living hinge in its open position. The previously missing hinge spring 11 feature has been added. It is a closed loop extension spring that goes through the two hinge spring slots 6-7. In this open position, the hinge spring pulls the hinge component connectors outward (opening force) but the hinge remains stationary because hinge component connectors 8-9 and ridges 1-5 are leaning against each other inhibiting further opening up.

FIG. 5 is a bottom isometric view of the complete detent living hinge in its open position. Hinge spring 11 is shown slotting through and looping around hinge spring slots 6-7 and pulling hinge component connectors 8-9 and ridges 1-5 toward each other (opening force).

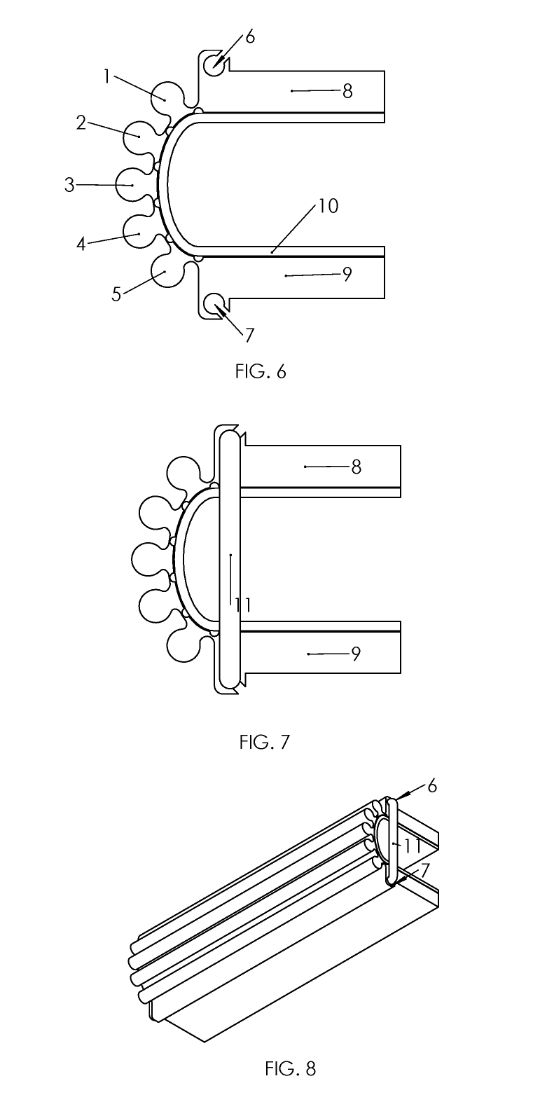

FIG. 6 is a side view of the detent living hinge without the hinge spring in its closed position. In this position, the imaginary components adhered to the hinge component connectors 8-9 lean against one another to inhibit further closing in.

FIG. 7 is a side view of the complete living hinge in its closed position. The missing hinge spring 11 is added. In this closed position, the hinge spring pulls the hinge component connectors 8-9 toward each other (closing force) but the hinge remains stationary because the imaginary components adhered to the hinge component connectors are leaning against each other to inhibit further closing in.

FIG. 8 is a bottom isometric view of the complete detent living hinge in its closed position. Hinge spring 11 is shown slotting through and looping around hinge spring slots 6-7.

It is clear that the hinge spring in the complete detent living hinge generates the force that pulls the hinge into one of two stable positions—closed and open.

The open detent is the hinge stable open position that resists against change but will change when sufficient closing force is applied. The open detent is supported by two forces—the hinge spring pulling force and the hinge component connectors and ridges counter-compressive force. The angle between two hinge component connectors in a stable open position can range from 0 to 360 degrees depending on the geometries of the hinge component connectors and ridges. In open detent, when sufficient closing force is applied, the hinge component connectors will start rotating toward each other.

The closed detent is the hinge stable closed position that resists against change but will change when sufficient opening force is applied. The closed detent is supported by two forces—the hinge spring pulling force and the connected components counter-compressive force. The angle between two hinge component connectors in stable closed position can range from 0 to 180 degrees depending on the geometries and shapes of the connected components. In closed detent, when sufficient opening force is applied, the hinge components will start rotating away from each other.

There are three zones—open, neutral, and closed—between the closed and open detents. Open zone covers the range of angles between the hinge component connectors that favors the hinge spring into pulling the hinge component connectors to its open detent. Closed zone covers the range of angles that favors the hinge spring into pulling the hinge component connectors to its closed detent. Neutral zone covers a small range of angles between the open and closed zones that does not favor the hinge spring into pulling the hinge component connectors to neither closed nor open detent. The geometries of the detent living hinge's five main features determine the ranges of the open, closed, and neutral zones.

The term “adhere” is referring to a general fastening method that can mean any combination of glue, weld, bolt, screw, and snap fit.

What is claimed is:

1. A detent living hinge comprising:
a thin flexible strip;
two hinge component connectors;
zero, one or plurality of hinge ridges;
two hinge spring slots; and
a hinge spring
wherein
the thin flexible strip adheres to the bases of the hinge component connectors and hinge ridges;
the hinge ridges are clustered together and situated between the two hinge component connectors;
each hinge component connector has a hinge spring slot;
the hinge spring is a closed loop extension spring;
the hinge spring slotted through and looped around the hinge spring slots; and
the detent living hinge has a closed detent, an open detent, a closed zone, an open zone, and a neutral zone.

2. A detent living hinge as claimed in claim 1, wherein
the thin flexible strip is made of any combination of cloth, paper, plastic, carbon fiber, rubber, and metal sheets;
the hinge spring is a coiled wire, rubber band, or elastic cord; and
the bases of the hinge component connectors and ridges are joined or disjointed.
